(19) United States
(12) Patent Application Publication
(10) Pub. No.: US 2019/0347604 A1
(43) Pub. Date: Nov. 14, 2019

(54) System and Method for Generation of a Process-Oriented User Interface

(71) Applicant: Gerald Suenram, Los Angeles, CA (US)

(72) Inventor: Gerald Suenram, Los Angeles, CA (US)

(21) Appl. No.: 16/406,114

(22) Filed: May 8, 2019

Related U.S. Application Data
(60) Provisional application No. 62/668,774, filed on May 8, 2018.

(51) Int. Cl. G06Q 10/06; G06F 16/22; G06F 16/28; G06F 7/08; G06F 9/451; G06F 16/2457; G06F 16/248

(52) U.S. Cl. CPC G06Q 10/063118; G06F 16/2291; G06F 16/285; G06F 3/04847; G06F 9/451; G06F 16/24578; G06F 16/248; G06F 7/08

(57) ABSTRACT

A method for presenting an improved user interface for domains and processes is disclosed. The method comprises defining within a database a plurality of domain records and a plurality of process records, with each process record associated with a domain record. A user interface is presented that generates domain graphical objects for each domain record to be displayed. Each displayed domain record is associated with a controlling process. The controlling process is determined by assigning a chronological category to each process, and further by applying an internal category prioritization to processes within a single category. Domain graphical objects are organized in the user interface based on the chronological category and internal category prioritization of their controlling process. The method further comprises displaying associated processes within the domain graphical objects. The displayed associated processes may be grouped within the domain graphical objects by assigned chronological category.

### RELATED APPLICATION

The present application claims the benefit of U.S. Provisional Patent Application No. 60/668,774, filed on May 8, 2018, the contents of which are hereby incorporated by reference in its entirety.

### FIELD OF THE INVENTION

The present disclosure relates to an improved computerized interface for organizing and displaying workflows and incidents based on multiple, integrated priorities.

### BACKGROUND

Assigning and scheduling activities are a ubiquitous challenge faced by individuals, organizations and industries. Current organization management systems use charting techniques to list, schedule, and track processes and tasks associated with projects. Many such systems are currently in release, including Asana™ (from Asana, Inc., San Francisco, Calif.), Wrike™ (from Wrike, Inc., San Jose, Calif.), and Smartsheet™ (from Smartsheet, Inc., Bellevue, Wash.), among others. These project management interfaces allow individuals and groups of users to organize their work as projects and track the progress of project tasks in various charts. Such systems also sometimes allow for time and profit analysis of projects or tasks related to projects.

For example, FIG. 1 shows a prior art user interface 100 for displaying tasks related to a process. This user interface 100 takes the form of a Gantt chart that shows a variety of tasks 110 for a single process. The various tasks 110 are set forth according to a timeline 120, which is shown near the bottom of the user interface 100. The various tasks 110 can be dependent upon each other, such that one task may not begin until another is completed. For example, task-1 112 must be completed before task-2 114 and task-3 116 can begin. Such an interface 100 successfully shows the workflow that must occur for a single process. While user interface 100 of FIG. 1 makes it easy to see the various tasks 110 that need to be performed for a particular process, this user interface cannot successfully organize and display the details of multiple processes or projects that must be performed by a single individual or business entity.

More specifically, conventional organization interfaces do not attempt to sequence and display all of a user's or organization's processes within a single, global chart. Further, conventional systems do not automatically and continuously sequence and display all of a user's or organization's processes such that the practical order for execution or incident of these may be displayed within a global chart. Furthermore, conventional planning systems are limited in their ability to organize and display workflows in total across a network of users such that their practical order is made clear to all. When the number of processes to be executed or to ensue exceeds the priority parameters of conventional planning systems or exceeds the user's ability to track and manually sequence workflows within the system, the user interface displays of prior art organization systems are deficient at eliminating human error, which leads to inferior management and poor performance.

Generally, the shortcoming in existing solutions is the absence of a method by which all the work of a user, user group or organization can be sequenced and presented by priority in a single computerized interface. None of the known prior-art systems provide for concatenating the entirety of an individual's or organization's processes by function area, process date-segmented categories, category rank and precedential chronology (of like-categorized workflows). Therefore, there is a need of a system and method for addressing the problem of inferior and insufficient information display in an organization chart (task management chart, project management chart, etc.). The present invention is directed to provide a fully integrated, automatically concatenating display of a user's, user group's, or organization's functions, processes and occurrences such that the priority order for execution or incident of these is made readily perceptible and accessible to all.

### SUMMARY

The embodiments of the present disclosure provide a method and interface for users to schedule and sequence processes (workflows and incidents) within an organization.

In one embodiment, a method for managing and displaying processes in an organization is disclosed. The method comprises defining and displaying a plurality of domains within the user interface wherein processes are associated with each of the domains. The method further comprises prioritizing processes within domains, and prioritizing domains based on a highest-priority process within the domains. The user interface then positions the plurality of domains within the presented interface based on processes of highest priority, and then repositions the domains within the display interface based on any change in the priority of processes within any domain.

In another embodiment, the method further comprises tier-designating the plurality of domains and positioning one or more domains within the user interface based on the corresponding tier.

### BRIEF DESCRIPTION OF THE DRAWINGS

For a more complete understanding of example embodiments of the present technology, reference is now made to the following descriptions taken in connection with the accompanying drawings.

FIG. 1 is a schematic illustration of a prior art user interface for displaying tasks that make up a process.

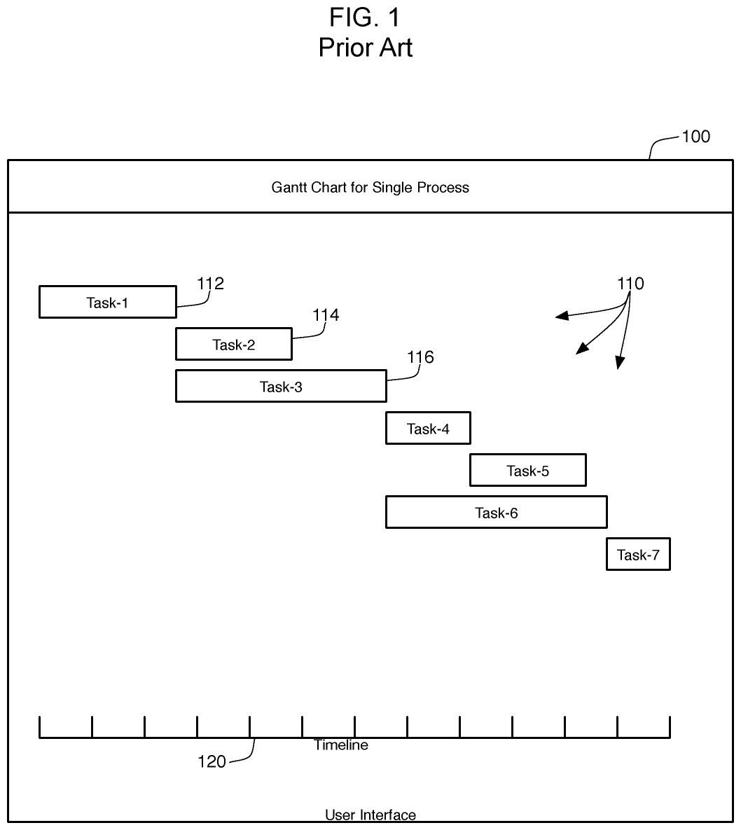

FIG. 2 is a schematic drawing showing the major components of a system for generating an improved user interface.

FIG. 3 is a schematic diagram showing the hierarchy existing between tiers, domains, processes, and tasks as presented in one embodiment of the user interface of the present invention.

FIG. 4 illustrates a flowchart depicting global system inputs, configurations and outputs, in accordance with the embodiments of the present disclosure.

FIG. 5 illustrates a flowchart of domain inputs, tier designation, and chart type settings, in accordance with the embodiments of the present disclosure.

FIG. 6 illustrates an exemplary drawing of a default domain constellation chart display prior to organization and prioritization.

FIG. 7 illustrates a flowchart of process and task inputs, scheduling, rescheduling or deletion, in accordance with the embodiments of the present disclosure.

FIG. 8 illustrates a flowchart of process positioning within a domain icon, in accordance with the embodiments of the present disclosure.

FIG. 9 illustrates a table of process location and positioning by chronological category, in accordance with the embodiments of the present disclosure.

FIG. 10 illustrates a table of process location and positioning within the interface by chronological precedence per category, in accordance with the embodiments of the present disclosure.

FIG. 11 illustrates in detail a portion of the user interface created by embodiments of the present disclosure.

FIG. 12 illustrates a flowchart of domain icon location and positioning by controlling process category, in accordance with the embodiments of the present disclosure.

FIG. 13 illustrates domain organization in a user interface, in accordance with embodiments of the present disclosure.

FIG. 14 illustrates the domain organization of FIG. 13, with three chronological categories of processes displayed within the domain icons, in accordance with embodiments of the present disclosure.

FIG. 15 illustrates another embodiment of a user interface in which process icons are organized and displayed with three chronological categories of tasks displayed within the process icons.

The drawings referred to in this description are only exemplary in nature.

### DETAILED DESCRIPTION

### System 200

In the following description, for purposes of explanation, numerous specific details are set forth in order to provide a thorough understanding of the present disclosure. It will be apparent, however, to one skilled in the art that the present disclosure can be practiced with details other than these specific details.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the Internet.

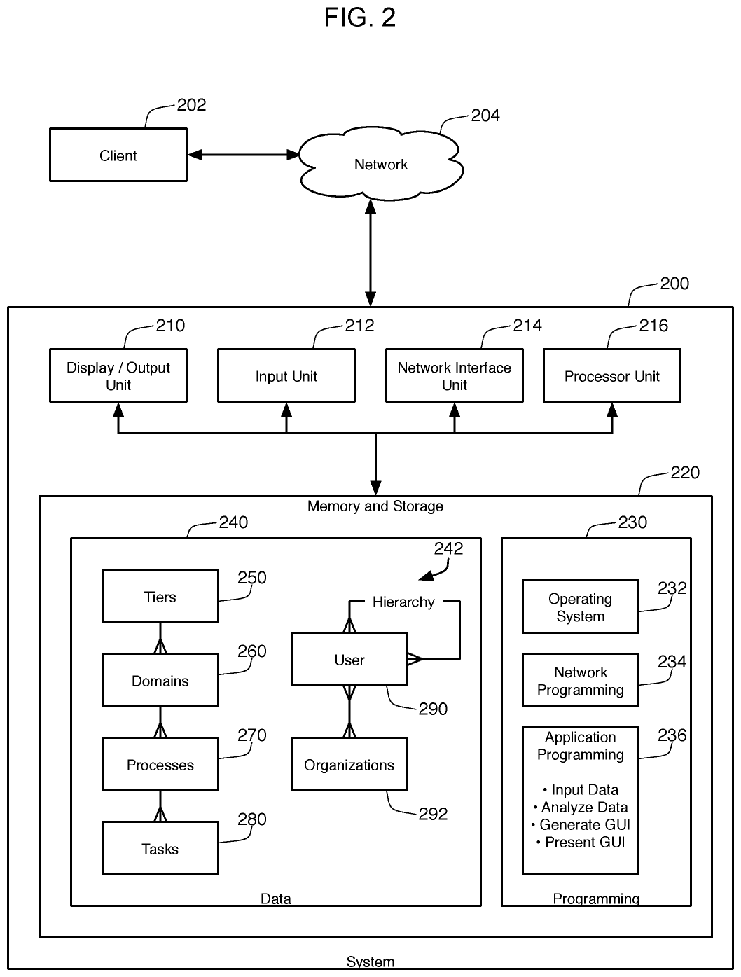

FIG. 2 shows a computerized system 200 that is capable of developing a user interface that overcomes the limitations of the prior art. The system 200 can be self-contained in that it provides the user interface locally over a directly attached display 210. Alternatively, the system 200 can operate as a server providing a user interface to a client computing device 202 that accesses the system 200 over a network 204, such as the Internet.

FIG. 2 shows, in a block diagram, the various components of the computing system 200. The computer system 200 may be implemented as a desktop computer, mobile device, a cloud-based server computer, or any other computing device or combination of devices that can receive data input from a user or users, process the received data, and present the user interfaces described herein. The system 200 is shown in FIG. 2 with a display 210. This display 210 presents a local user interface display to a user. The system 200 also includes an input unit 212 that is responsible for receiving input from a user. When the system 200 operates locally, the user input can be received through a locally connected keyboard and mouse, through a trackpad, through a touchscreen display, or any other known type of computerized user input device. In order to communicate over the network 204, the system 200 includes a network interface unit 214 that is responsible for formatting, transmitting, and receiving communications over the network 204. Typically, the network interface unit 214 includes the hardware components necessary to communicate over the network 204. Communications over the network 204 can take the form of the TCP/IP protocol or any other networking protocol that allows for data communications between computing devices 200, 202 over a network 204. When the system 200 operates as a server, the network interface unit 214 and the input unit 212 can together receive and interpret input from the client device 202 over the network 204. In other embodiments, communications with the client 202 pass only through the network interface unit 214, with the input unit 212 responsible only for communications with local devices. In further embodiments, the input unit 212 takes the form of a standard input/output computing component, handling both data input and output with locally attached i/o devices.

A processor unit 216 in the system 200, along with other components and instructions stored in the memory 220, is responsible for various tasks and functions provided herein. In one embodiment, the processor unit 216 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In most cases, the processing unit 216 is a CPU, such as the CPU devices created by Intel Corporation (Santa Clara, Calif.), Advanced Micro Devices, Inc (Santa Clara, Calif.), or a RISC processer produced according to the designs of Arm Holdings PLC (Cambridge, England). The processor unit 216 is capable of executing the machine executable programming instructions stored in the memory 220 or within any storage location accessible to the processor unit 216.

The memory and storage component 220 may include both temporary, random access memory (RAM) and more permanent storage such a magnetic disk storage, FLASH memory, or another non-transitory (also referred to as permanent) storage medium. The memory and storage component 220 (also referred to as “memory” 220) contains both programming instructions 230 and data 240. In practice, both programming 230 and data 240 will generally be stored permanently on non-transitory storage devices and transferred into RAM when needed for processing or analysis.

The programming includes an operating system (or OS) 232, which can take the form of a server or workstation operating system such as Windows (Microsoft Corporation, Redmond, Wash.) or Mac OS (Apple Inc., Cupertino, Calif.), or a mobile device operating system such as Android (Google LLC, Menlo Park, Calif.) or iOS (Apple Inc.). In situations where the computer system 200 operates as a server, separate network programming 234 may be included to handle data request and interface presentation for the client computing device 202. For example, the network programming 234 may take the form of web server programming that presents web pages to a browser operating on the client device 202.

The application programming 236 receives data and instructions from a user, stores data 240 in the memory 220, analyzes the data 240 based on instructions and requests from the user, generates the user interface, and then presents the user interface to the user. The user interface can be presented either locally on the display 210 or remotely on the client device 202 using the network programming 234, the network interface 214, and the network 204 itself to communicate with the client 202.

The application programming 236 relies upon a particular configuration of the data 240. The data 240 can be structured and stored as a traditional relational database, as an object-oriented database, or as a key-value data store. Regardless of its implementation, the data 240 found in memory 220 is internally structured in a manner similar to the data organization 242 shown in FIG. 2. This data organization 242 shows relationships between separate data entities 250, 260, 270, 280, 290, and 292 using crows-foot notation. These entities 250-292 might constitute data tables in a relational database, data objects in an object-oriented framework, or key-value pairs. For ease in discussing this data 240, these entities will generally be referred to as data tables or data records even if the “data record” is actually implemented as an instantiated object or key-value pair. Furthermore, each record can be considered to have “attributes” which store organized data for that record. The word attribute can be considered a variable that stores information but may also be used to refer to the value stored within this variable. This language will again be used regardless of the actual implementation details of the data organized 240. A person of ordinary skill will understand that an attribute of a record in a table has natural corollaries to other data implementations, and therefore such language should not be limited to a particular data implementation. Furthermore, note that each table 250-292 will contain many data records. Nonetheless, in describing the relationship between data entities 250-292, this description may refer to an individual data record using the figure number used in FIG. 2 for the entire table. Furthermore, references to the data 240 in general may also be made by referring to database 240, as it is likely that the data 240 will be formalized into some type of database.

According to the notation shown in FIG. 2, the data 240 primarily consists of data related to tiers 250, domains 260, processes 270, and tasks 280, as well as data about users 290 and organizations 292. Based on the crows-foot notation, it can be seen that data records in the tiers table 250 can be associated with multiple domains 260, while each domain 260 is associated with only a single tier 250. Similarly, each record in the domains table 260 can be associated with multiple process records 270, while each process 270 is associated with a single domain 260. Finally, each process 270 can be associated with multiple tasks 280, but each task 280 is associated with a single process 270.

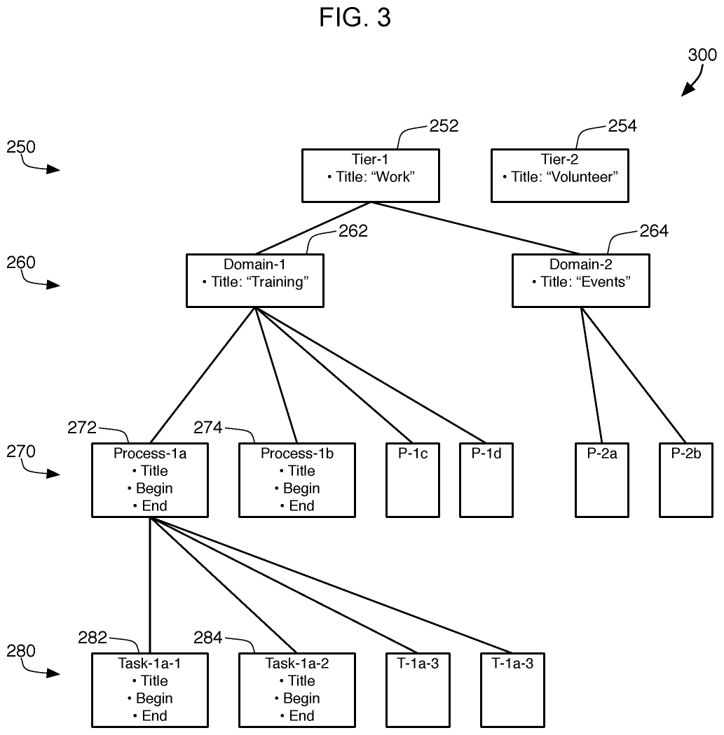

This defined organization of the data 240 creates a hierarchy of data records, such as the data record hierarchy 300 shown in FIG. 3. Records in the tier table 250 are shown in the top of hierarchy 300, namely Tier-1 252 and Tier-2 254. Records from the domain table 260 are shown in the second row in hierarchy 300, namely Domain-1 262 and Domain-2 264. These two records 262, 264 are both shown as being related to the Tier-1 record 252. Records on the third row are process records 270. The first four process records 270, including Process-1a 272 and Process-1b 274 are related to Domain-1 262, while the other two process records 270 shown in FIG. 3 are related to Domain-2 264. Finally, records on the fourth row are task records 280. All four task records 280 shown in FIG. 3 are related to Process-1 272, including Task-1a-1 282 and Task-1a-2 284.

The benefit of establishing this hierarchy 300 in the database 240 is that this structured data can be utilized to represent and manage real-world process management situations. For example, data relating to domains 260 can be considered the “domains” of an individual's responsibility. For instance, a professional user may manage a large number of functional domains for their job (e.g., Employee Benefits, Training, Events, Employee Manuals), while having other responsibilities for their volunteer activities outside their job (e.g., Fundraising or Volunteer Recruitment). These large responsibilities (Training or Fundraising) would be example of domains, which are stored in domain data entities 260. Domains 260 can be grouped together into tiers 250 in the database 240, just like the user's Fundraising and Volunteer Recruitment activities can be grouped together as volunteer activities. In FIG. 3, The Tier-1 252 record is shown containing an attribute called Title that has a value of “Work,” which indicates that this record 252 represents the “Work” tier. The other tier record 254 has a title of “Volunteer.” The “Work” tier record 252 can have multiple domains associated with it. In FIG. 3, Domain-1 262 is used to track processes related to the user's Training responsibilities, while Domain-2 264 tracks the user's Events responsibilities. Data 240 in hierarchy 300 tracks four different processes 270 for the Training domain record 262 including Process-1a 272, and also four different tasks 280 for Process-1a 272.

FIG. 3 indicates that the process records 270 contain Begin and End attributes. These attributes can track the intended beginning time and/or date for the process, as well as the ending time and/or date. For simplicity, further references to beginning and ending times and/or dates will simply refer to the begin or end “time,” and this time will be assumed to be something that can be represented either as time or date. Although FIG. 3 shows separate entries for both the Begin and End times, it is also possible that the same information could be encoded using an expected Duration attribute and only one of the Begin or End times. FIG. 3 also indicates that Tasks can be assigned Begin and End times.

Returning to FIG. 2, the database 240 also includes a user table 290, which tracks individual users of the system 200. Each user record 290 can be associated with multiple organizations 292, and each organization 292 can be associated with multiple users. User records 290 can be associated with each other, so as to create a hierarchy between individual user records 290. For instance, a first user may be a “boss” of a second user, with the second user being the “boss” of a third user. Individual records in the tiers table 250, the domains table 260, the processes table 270, and the tasks table 280 can be associated individual user and organization records 290, 292. These relationships can then be used to create user interfaces that provide information for all processes being handled by that individual, or by a group of individuals that report to a particular user.

The hierarchy among user records 290 allows an officer in an organization to manage and monitor the processes 270 and tasks 280 of those individuals that report to them (“follower” users). As explained below, it is possible to group and present processes 270 in a user interface using domains 260 and tiers 250. In some embodiments, the hierarchy of users created through the interconnection of user records 290 can be used to automatically generate the necessary domains 260 and tiers 250 of processes associated with those user records 290. In addition to allowing individuals at the top of the user record hierarchy 290 to see processes 270 of their follower users, it is also possible to have tier 250 and domain records 260 associated with boss user records be used to organize processes for these follower users. In other words, domains 260 created and controlled by a boss user may also be incorporated within the interfaces of their follower users.

The application programming 236 provides a user interface that allows a user associated with an organization to register with the system 220, thereby establishing user 290 and organization 292 records for that user. The application 236 also allows the user to establish new records for tiers 250, domains 260, processes 270, and tasks 280, and to create the relationships between these records 250-280 that create the data hierarchies such as hierarchy 300 shown in FIG. 3. This process includes entering titles for each of these records, and scheduling information defining the beginning and/or ending times for the process 270 and task 280 records.

### Overall Process 400

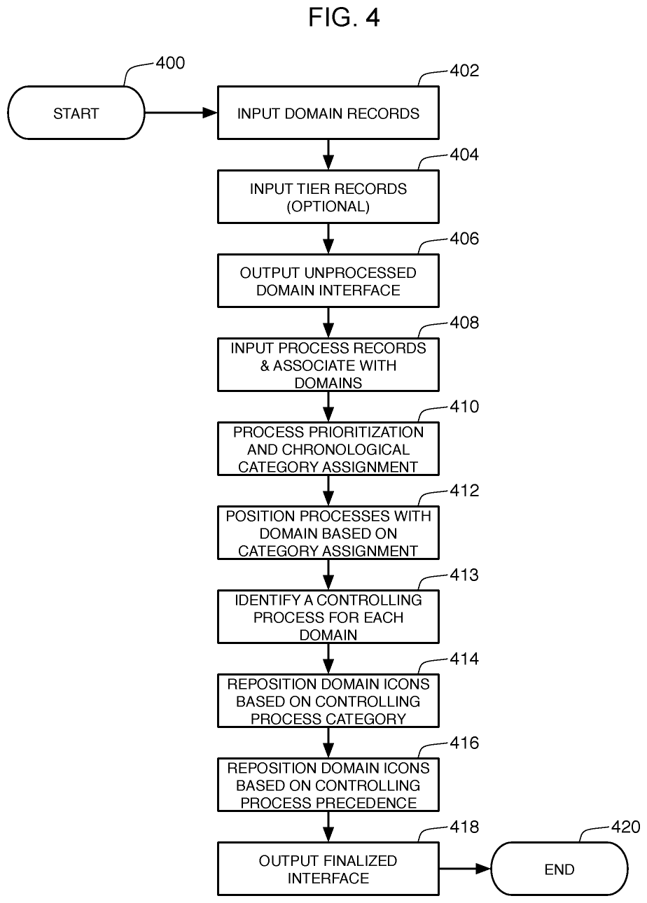

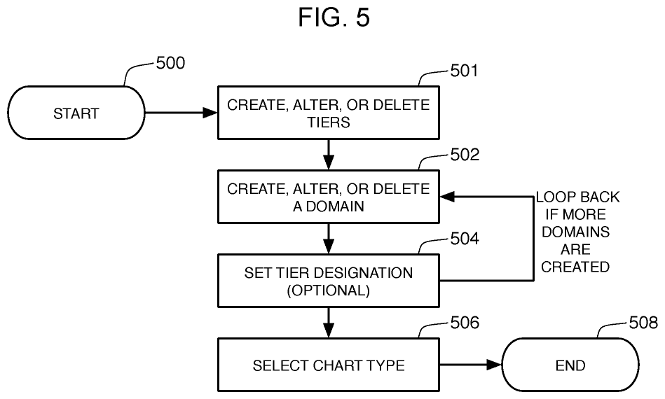

Referring to FIG. 4, an overall method 400 for generating the improved interfaces of the present invention is illustrated. At step 402, upon engaging the system 200, a user is prompted to create domain data records 260, including titles for each record, for all domains that the user and her organization expect to be handled by the system 200. At step 404, the user may then enter tier data records 250 to allow the various domains 260 to be grouped together within the resulting user interface (as described in more detail in reference to flowchart segment 504 in FIG. 5). The ability to group domains 260 by tiers allows the virtual creation of “a chart within the chart.”

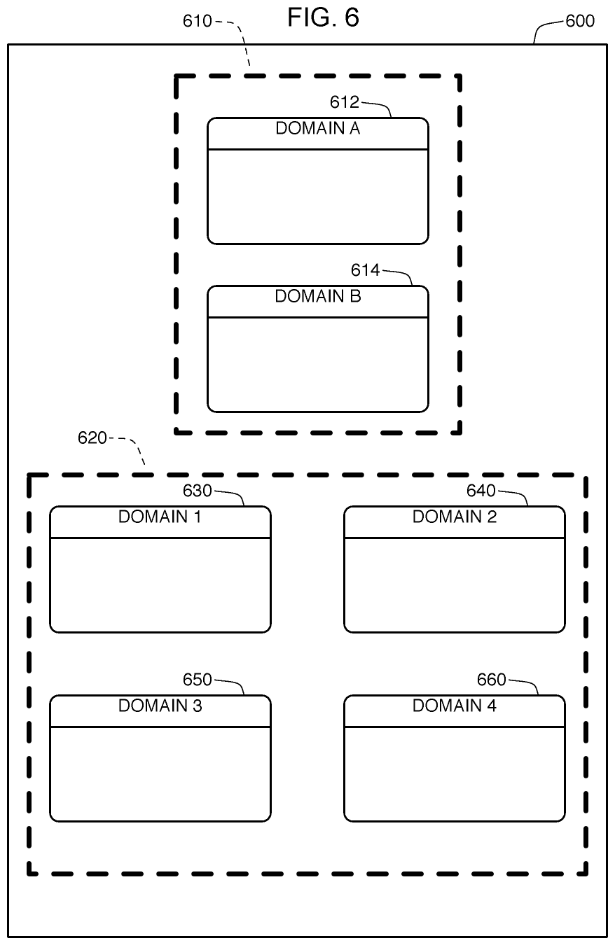

At step 406, following initial domain inputs, the system 200 is able to generate a user interface 600, as illustrated in FIG. 6. At this point, no processes 270 have been defined, only tiers 250 and domains 260. Hence user interface 600 visually represents only these elements 250, 260. In particular, interface 600 shows two tiers 610, 620 that each group together their associated domains 612-614, and 630-670, respectively. At this point, there is no attempt to present the tiers 250 and domains in any prioritized fashion—interface 600 just presents this information in an ordinary manner such as alphabetically by title or by order of creation.

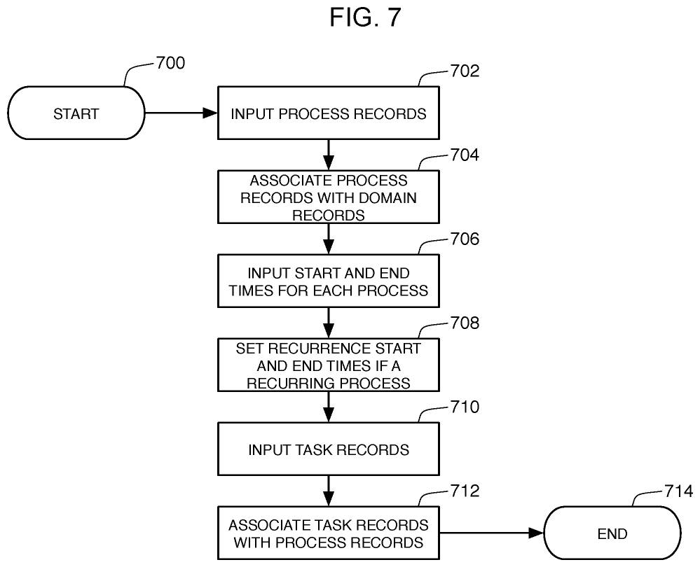

At step 408, the user will then enter information to create and populate with data a plurality of process data records 270. In creating a process record 270, the user will input the processes title, and the begin and end time for the process. The user will be responsible for associating the created process record 270 with a particular domain record 260. The entry of a process record 270 is described in more detail in reference to flowchart in FIG. 7.

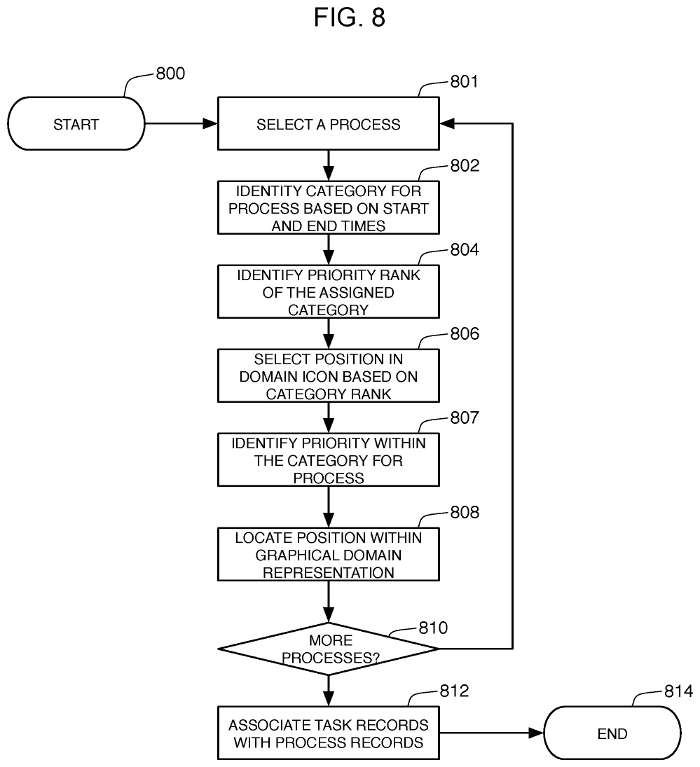

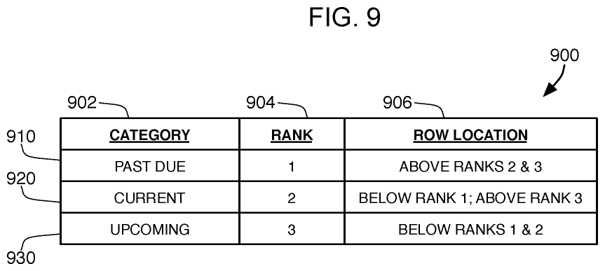

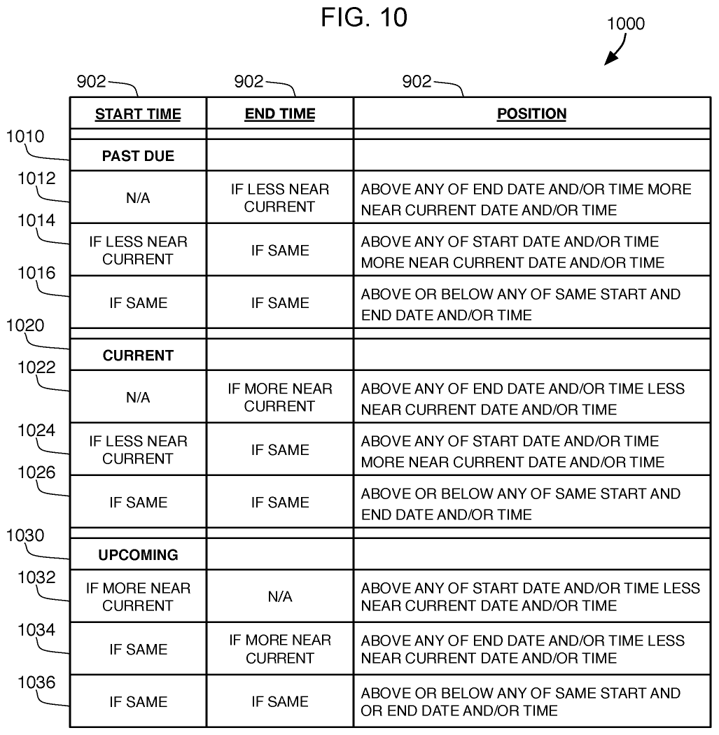

At step 410, the application programming 236 analyzes the inputted process records 270 in order to prioritize processes and assign a chronological category to the process 270 based on their start and end times (as described in more detail in reference to FIG. 8 and FIG. 9). At step 412, the system 200 is programmed to update the presented user interface by identifying processes 270 associated with the domains 260 based on chronological category assignment given to the process 270. (as described in more detail in reference to FIG. 8 and FIG. 10). The updated interface is described in more detail below.

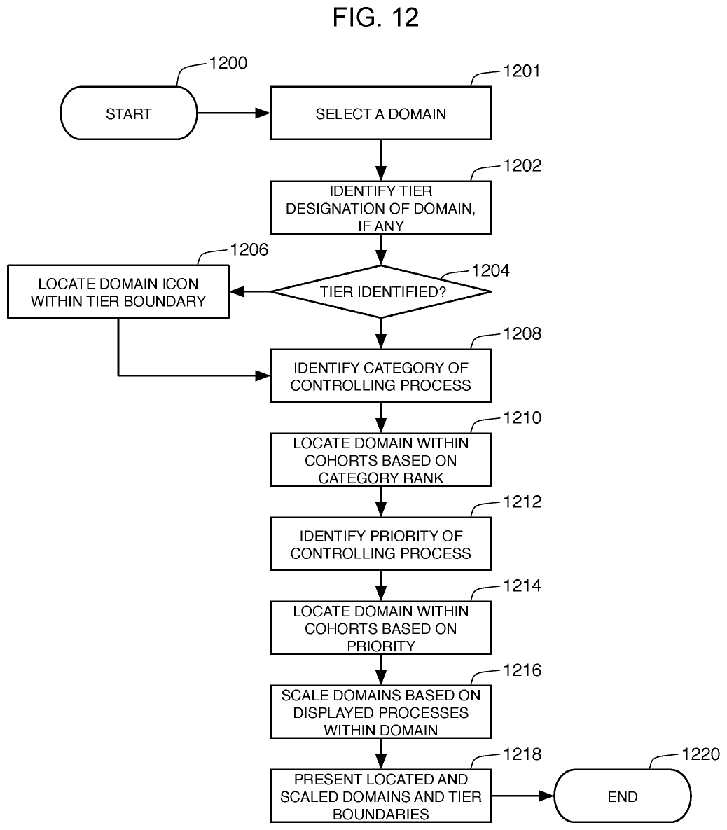

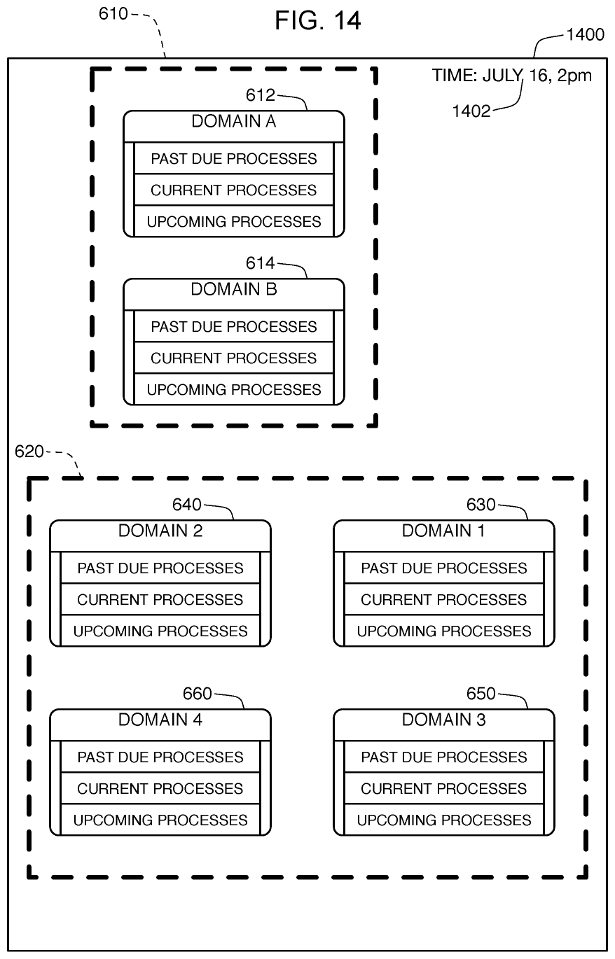

At step 413, the controlling process 270 for each domain 260 is identified. The controlling process 270 is that process 270 associated with that domain 260 that has the highest priority as determined by step 410. At step 414, the domain icons in the user interface are repositioned within the interface based on priority of the chronological category of the controlling process determined at step 413 (as described in more detail below in connection with FIG. 12). At step 416, the domain icons in which controlling processes are of like category are then positioned within the interface by chronological precedence of the controlling process start and end times (also described in more detail below in connection with FIG. 12). Finally, at step 418, the system 200 is programmed to then output the finalized interface (as illustrated at FIG. 14). As part of step 418, the user may optionally set the chart date or time range for the finalized interface. The process 400 then ends at step 420.

### Tiers and Domains Process 500

FIG. 5 shows a method 500 for inputting tiers 250 and domains 260 within the system 200. The process starts at step 501, during which the user is provided an interface by application 236 to input, alter, or delete tier records 250. Each newly defined tier should have a name or title. In addition, in some embodiments the user will manually assign a ranking or priority to individual tiers. This step 501 will allow users to create multiple tiers 250, and to modify or delete existing tiers 250 in the database 240.

At step 502, a user may input, alter or delete a domain 260 to be graphed through a data entry window in the application 236. Entering or altering the domain 260 may include adding or changing a title for the domain to be used by the system 200. The system 200 may be programmed to require that a title be entered of each domain 260 that the user wishes to graph. At step 504, the user may then designate, at the user's option, to separately order and graph the domain within a tier 250, such as “Tier-1” 252 or “Tier-2” 254. The system 200 is programmed to record and save any such tier designation for the entered domain 260. The system 200 may loop back to step 502 if more domains 260 are to be created.

Once the domains 260 are entered into the system 200, the system 200 will group within the chart all like-tiered domains. This creates that “chart within the chart” view shown in FIG. 6, with domains in the same tier being grouped together, with the tiers 610, 620 being manually prioritized by the user as described above at step 501. The tier 610, 620 of the highest, manually assigned priority is graphed at a position of higher priority relative to lesser priority tiers. In FIG. 6, the first Tier 610 has precedence over Tier 620, and is displayed higher in the interface 600. In addition, since domains A 612 and B 614 are affiliated with the same tier (Tier 610), they are displayed in interface 600 “within” that tier. In FIG. 6, each tier is shown through the use of a thick, dashed border, with domains associated with the tier having icons or other graphical devices being located within the border. Thus, domains 630-660 are displayed within the border that shows tier 620. All domains 260 are positioned within the border of their tier 250 and are ordered according to their category priority and precedential chronology, as is described in further detail below.

At step 506, following the saving of organization domain titles, and tier-designations, if any, the user may select the type of chart to be displayed, or default to the exemplary chart type (for example, as depicted in FIG. 6). The system 200 may automatically default to the default chart type in case required by the domain, or process data inputted by the user. Other types of charts are possible. For example, other charts might change the shape and color of the outlines and icons used to represent the tiers 250 and domains 260 in the interface. In the various embodiments of the present invention, the graphical presentations of the individual elements may vary as long as the prioritization and concatenation provided by the interfaces remains intact.

### Process and Task Records Method 700

Now referring to FIG. 7, a method 700 for establishing the process records 270 is shown. The method 700 starts at step 702, where the user is provided an interface to input process records 270 into the data 240. This step will include the ability to alter or delete existing process records 270. Each process record 270 must have a title or name assigned to it in step 702. At step 704, the user will associate any new process records 270 with a particular domain record 260 in order to create a hierarchy similar to hierarchy 300 shown in FIG. 3. At step 706, the user is required by the application programming 236 to input the starting and ending times for each process 270. In some embodiments, if the start and end times are not entered, the system 200 is programmed to indicate that the start and end times are mandatory data fields that must contain valid data for the creation of a process. Of course, the application 236 may allow users to alter or amend the starting or ending times of previously inputted processes 270.

At step 708, the user may set a recurrence start and end time of a recurring associated process. A recurring process is a process that restarts automatically at a given time interval or restarts upon the completion of the event itself. In other words, a recurring process does not need to be manually created by a user but is automatically created by the system 200. For example, a monthly report that requires gathering and reporting sales data for a company may be implemented as a recurring process. Once again, the application 236 can allow users to alter or amend the settings for a recurring process well after the creation of the process.

At step 710, the user will input new task records 280 into database 240. The application 236 will provide an input window for a user to create a new task 280, to receive a title/name for the task 280 and to assign starting and ending times for the task 280. At step 712, newly created tasks 280 are assigned to a process 270 as part of the data hierarchy previously described. In one embodiment, the inputting of individual tasks 280 at steps 710 and 712 is optional. In these embodiments, tasks 280 are not graphed and displayed in the interfaces described herein. In other embodiments, tasks 280 are an important part of the described interface. Tasks 280 can be prioritized using the same method and priorities that are described below in connection with processes 270. The process 700 for establishing process records 270 and task records 280 then ends at step 716.

Both process 270 and task records 280 are generally associated with ending times that represent a time deadline for completion of the process 270 or task 280. Once a project is complete, the user interfaces described herein will provide the ability to mark the process 270 or task 280 complete. This is generally accomplished by maintaining a completion attribute for the process 270 and task records 280, where the completion attribute either simply identifies the completion status, or identifies the time of completion. In most cases, completed processes 270 and tasks 280 will no longer be presented on the user interfaces, and will no longer influence the ranking and position of domains 260. Completed records can be maintained by the system for later review by the user, including through the display of all completed processes 270 and tasks 280 for a particular time frame or for a particular domain 260 or tier 250.

### Method 800 For Positioning Process Data in Domains on Interface

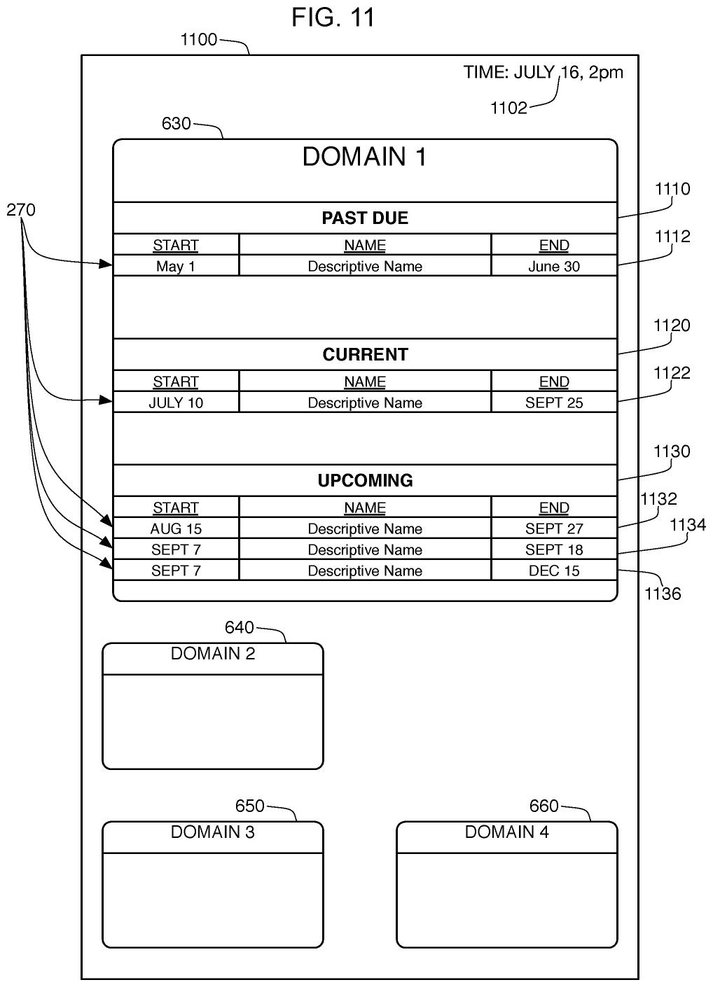

FIG. 8 shows a method 800 by which the system 200 determines how processes 270 will be prioritized and displayed in the described interfaces. For example, FIG. 11 shows a user interface 1100 that is similar to interface 600 of FIG. 6. Interface 1100 only shows the domains 630-660 found in tier 620. In addition, domain 630 is shown with those processes 270 associated with the domain 630 being inserted into the icon/graphical representation of the domain 630 on the interface 1100. Only domain-1 630 is shown with its associated processes 270 in FIG. 11 due to practical considerations in displaying the details of the processes 270. In actual implementations, the other domains 640, 650, 660 would also have associated processes 270 displayed therein. The method 800 provides the ability to categorize and sort the displayed processes 270 according to one embodiment of the present invention.

Method 800 starts at step 801, where a single process 270 associated with the domain 260 to be presented is selected for analysis. At step 802, the system 200 analyzes the starting and ending time for the selected process 270, and then identifies a category for that process 270. While it is possible to establish different categorization for processes, one embodiment uses one of three chronological categories: “Past Due,” “Current” or “Upcoming.” These categories are shown in table 900 found on FIG. 9. Past Due processes are those of a start and end time preceding the current time. Current processes are those of a start time of or preceding the current time and an end time of or following the current time. Upcoming processes are those of a start time and end time following the current time. A rank 904 is assigned to each category 902 in order to determine which chronological categories 902 should take precedence over others during the display of the data 240. The Past Due category 910 has a rank 904 of 1, while the Current category 920 has a Rank 904 of 2. In this case, categories 902 that have a lower number for their rank 904 in table 900 are considered to rank higher, and therefore take precedence over categories 902 that have a larger number for their rank 904. Thus, the Past Due category 910 is ranked higher than the Current category 920, which is ranked higher than the Upcoming category 930.

In another embodiment, the Current categories 920 can be split into two separate categories 902: “Now Current” and “Ongoing.” The Now Current category (which can also simply be referred to as “Current”) includes those processes having a start time equal to the current time, with the Ongoing category being those processes having a start time before the current time and an end time on or after the current time. In this embodiment, the rank 904 of these categories 902 is as follows: Current has a rank of 1, Past Due has a rank of 2, Ongoing has a rank of 3, and Upcoming has a rank of 4. Other than the additional category 902 and change in ranks 904, this embodiment is otherwise similar to the process described herein in connection with FIG. 9.

These categories are used to position processes 270 in interface 1100. More particularly, the presented embodiment uses rectangles to represent domains 630, 640, 650, 660 on interface 1100. The processes 270 associated with each presented domain 260 is typically shown within that geometric shape. The positioning of the process 270 within that shape is based in part upon its assigned category based on table 900. Table 900 assigns a category value 902 and an associated categorical rank 904 and categorical location 906 to each process 270. A process 270 of a Past Due category 910 is of first priority rank and is located at a row above all processes 270 that have category 902 of second or third priority rank 904. A process 270 of a Current category 920 is of second priority rank and is located at a row above a process of a category of third priority rank. A process of an Upcoming category 930 is of third priority rank and is located below a process of a category of first or second priority rank.

In FIG. 11, process 1112 is assigned to the Past Due category and therefore is positioned near the top of the representation of the domain 630 underneath the Past Due category heading 1110. Process 1122 is assigned to the Current category and therefore is placed toward the center of domain-1 630 underneath the Current category heading 1120. Processes 1132, 1134, and 1136 are Upcoming processes, and are located under the Upcoming category heading 1130 near the bottom of Domain-1 630. Although higher priority ranks in FIG. 11 resulted in a placement vertically above processes 270 of lower priority or precedence, it is possible to implement the present invention through the use of horizontal positioning or by positioning in 3D.

Returning to flow chart 800 of FIG. 8, the system 200 at step 804 identifies the priority rank 904 of the category assigned to the process 270. At step 806, the system 200 locates a position within the displayed icon for the associated domain 260 at which the process 270 will be positioned based on the priority rank.

At step 807, it is necessary to prioritize the process 270 with respect to all the other processes 270 associated with the same domain 260 that also have the same assigned category 902. This can be considered the internal category prioritization, since it prioritizes processes 270 within the same category 902. In the example of interface 11, processes 1132, 1134, and 1136 are all assigned to the Upcoming category 930 and would therefore need to be prioritized relative to one another. Process prioritization is preferably assigned using the position assignments set forth in table 1000, as shown in FIG. 10. Precedence for each category 902 is assigned at different portions of the table, with portion 1010 handling processes 270 with a Past Due category 910, portion 1020 handling processes 270 with a Current category 920, and portion 1030 handling processes 270 with an Upcoming category 930.

There are three different possibilities in each category portion 1010, 1020, 1030 of table 1000, which are determined by the relationship between start and end times of the process 270 and the current time. In the instance in which the system 200 locates within a domain icon more than one Past Due process 270, row 1012 of table 1000 locates a Past Due process of an end time less near the current time at a row above a Past Due process 270 of an end time more near the current time. In other words, Row 1012 prioritizes Past Due processes based on the “farness” of the end time to the current time. Row 1014 handles Past Due processes having the same end time. In this circumstance, a Past Due processes 270 having start time less near the current time is positioned at a row above such a Past Due process 270 having a start time more near the current time. This means that the secondary prioritization for Past Due processes 270 (Row 1014) is based on the farness of the start time from the current time. If both the start and end times for two Past Due processes 270 are the same, row 1016 indicates that these processes 270 can be located either above or below each other.

Portion 1020 of Table 1000 handles processes assigned to the Current category 920. Row 1022 indicates that the precedence of a Current process is first established by end time. In the instance in which the system 200 locates within a domain 260 more than one process 270 in the Current category 920, the process 270 of an end time more near the current time is positioned above a process 270 of an end time less near the current time. Row 1024 handles instances where such processes 270 have the same end time. In these circumstances, the process 270 with a start time less near the current time is positioned above a process 270 of a start time more near the current time. These two rows 1022, 1024 thus show that the primary sorting of a Current process is based on the nearness of the end time to the current time, and the secondary sorting is based on the farness of the start time to the current time. As indicated by row 1026, processes 270 for the same domain 260 that are both assigned to the Current category 920 and have the same start and end time can be placed in any order relative to one another.

Portion 1030 handles processes 270 assigned to the Upcoming category 930. Row 1032 indicates that the precedence of an Upcoming process 270 is first established by start time. Upcoming processes 270 having a start time more near the current time is positioned above an Upcoming process 270 having a start time less near the current time. When the start times for two Upcoming processes 270 are the same, row 1034 indicates that the process 270 having an end date more near the current time is positioned above any process 270 having an end time less near the current time. The primary sorting for Upcoming processes is therefore based on the nearness of the start time to the current time, with the secondary sorting based on the nearness of the end time to the current time. Row 1036 indicates that processes 270 of this type having the same start and end time may be positioned in any order relative to one another.

With respect to FIG. 11, the current time 1102 is indicated to be July 16 at 2 pm. Process 1132 is considered to have a start time that is closest to the current time, and therefore process 1132 is considered to have the highest priority based on row 1032 of table 1000. Processes 1134 and 1136 both have the same start time (September 7), so their relative priorities are determined by row 1034. Process 1134 has an end time more near the current time, and therefore has a higher priority relative to process 1136. Note that the combination of the chronological category rank 904 and the prioritization from table 1000 create a combined or overall ranking for the processes 270, with the highest overall rankings appearing higher within Domain-1 630 in FIG. 11.

Returning to FIG. 8, after table 1000 is used at step 807 to identify a priority within the categories 910, 920, 930 for the process, the system 200 at step 808 locates the exact position for the process selected at step 801 within the icon or other graphical representation of the domain 260 in the interface. The method then determines if other processes exist that need to be prioritized at step 810. If so, the process returns to step 801 to select the next process 270. Once all the processes 270 are prioritized, step 812 will generate the graphical icons or shapes that represent the domains 260 with the processes 270 for each domain 260 properly prioritized and position within each domain 260. The result is interface 1100 (with, of course, the processes 270 for domains 640, 650, and 660 also included in the interface 1100). The method 800 then ends at step 814.

Following the conclusion of method 800, the process 270 of highest-priority is positioned at the topmost row within the domain icon. For Domain-1 630, the highest-priority process 270 is process 1112. This highest-priority process 1112 is considered the controlling process for the domain.

In some embodiments, the user can control the time frame covered by interface 1100. For example, the user can specify a time duration, specified in days, hours, or even minutes. The interface 1100 will then only present domains 630, 640, 650, 660 that have processes 270 with start dates that occur before or within the specified time frame. In FIG. 11, all of the start dates for the processes 270 displayed in Domain-1 occur within one month of the current date 1102. In an exemplary embodiment, the default date and/or time range is ninety days from the start date and/or time.

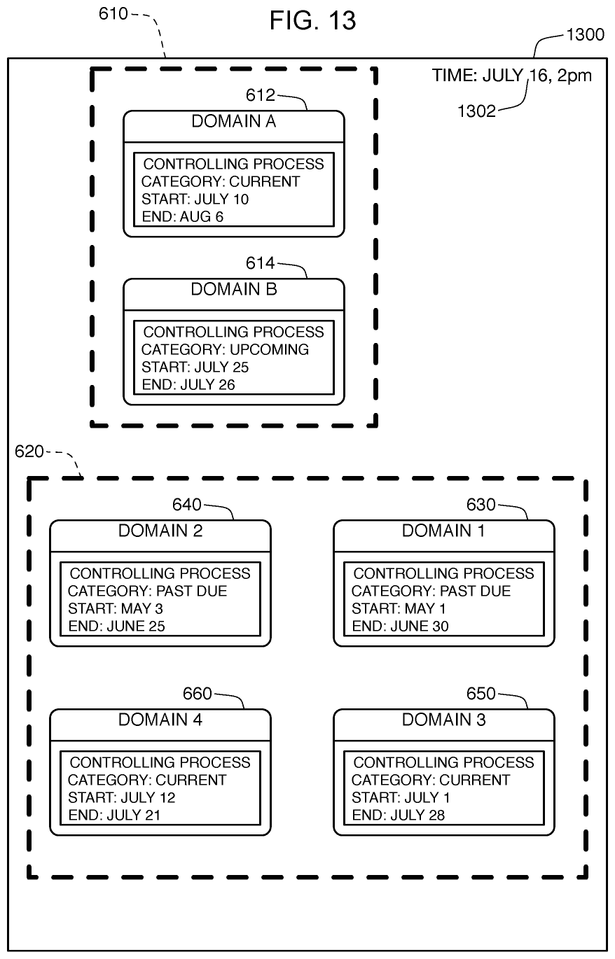

FIG. 12 shows a method 1200 by which domains 260 are positioned relative to one another. The method begins at step 1201, in which a single domain 260 of the domains to be displayed is selected for analysis. At step 1202, the system 200 identifies whether the selected domain 260 is associated in the database 240 with a tier record 250. If step 1204 determines that a tier 250 is associated with the selected domain 260, then the domain 260 will have its domain icon presented in the user interface within a boundary for that tier 250 at step 1206. Such a boundary can be seen in user interface 600 of FIG. 6 as well as user interface 1300 of FIG. 13. In both cases, Domain A 612 and Domain B 614 are located within the first tier boundary 610, with the other domains 630, 640, 650, and 660 being located within the second tier boundary 620. If no tier designation is identified in step 1202, the system 200 does not need to locate the domain icon within any tier boundary 610, 620 in the user interface. In other cases, only domains 260 within a single tier 250 are to be displayed, or the user has elected through preferences not to divide domains 260 into separate tiers 250. In either of these cases, steps 1202-1206 can be skipped, and no domain boundaries 610, 620 will be displayed on the interface.

At step 1208, the system 200 identifies the category 902 and category rank 904 of the controlling process within the domain icon. As explained above, the controlling process is the process 270 within a domain 260 that has the highest priority (process 1112 in FIG. 11). At step 1210, the system 200 locates the position of the domain icon for the selected domain within the user interface relative to other domain icons in the same tier 250 or other domain icons that are not located within a tier boundary. Step 1210 effectively starts the process of prioritizing the domain icon in the user interface, such as user interface 1300. The prioritization is done separately for each tier 250 as long as tiers 250 are being presented in the interface 1300. In other words, the domains 260 are sorted against the “cohorts” of the domain icon, with the cohorts being limited to those domains that were treated similarly in steps 1202-1206. In this way, each tier 250 is handled and prioritized separately in a user interface.

Step 1210 prioritizes the domains based on the chronological category 902 of the controlling process. A higher priority domain icon is denoted by positioning the icon above or to the left of a domain icon of lower priority. Alternatively, higher priority may be denoted by using a more foreground position, or a more substantial scale, or a quantified color or other indicator within a chart relative to a domain icon of lower priority. In FIG. 13, Domain A 612 has a controlling process with a category of Current, while Domain B 614 has a controlling process with a category of Upcoming. As indicated by table 900, the Current process has a higher rank, and therefore Domain A 612 is positioned above Domain B 614 in interface 1300. Similarly, Domain-1 630 and Domain-2 640 both have controlling processes with chronological categories of Past Due, which makes them of higher priority than Domain-3 650 and Domain-4 660 that have controlling processes with category of Current.

In some embodiments, domains 260 may exist that do not have a controlling process. This may occur when no pending processes 270 exist for the domain. In addition, this can occur when the time duration for a user interface does not include any processes 270 for a domain 260. For example, a user may wish to only view processes 270 that have a starting date within one month of the current date. If the only processes 270 for a domain 260 have starting times that begin more than one month from the current date, there will be no processes 270 to be displayed for a domain 260. In this case, the domain 260 will be considered to have no controlling process. Domains 260 with no controlling process are considered to have a categorical rank of 4, meaning they have a lower rank than domains 260 having a controlling process of a Past Due 910, Current 920, or Upcoming 930 category 902 in table 900.

Returning to FIG. 12, the process continues at step 1212, wherein the prioritization of the controlling process for the selected domain 260 is analyzed and identified using table 1000, with the domain icons then arranged within the user interface 1300 according to the results at step 1214. As explained above, Table 1000 is used to prioritize within a category 902. If the controlling process for a first domain 260 is a Current category 920 and the controlling process for a second domain 260 is Upcoming, then there would be no need to consult table 1000 to prioritize between the two domains. Table 1000 is used to prioritize domains based on the controlling process in step 1212 in the same manner that it was used to prioritize between processes at step 807. Domains 260 without any controlling process are not further prioritized at steps 1212 and 1214. As before, a higher priority may be denoted in a variety of ways, such as by positioning of a domain icon above or to the left relative to a domain icon of lower priority.

Returning to FIG. 13, it can be seen that Domain-1 630 has a start date of May 1 and an end time of June 30, while Domain-2 640 has a starting time of May 3 and an end time of June 25. Since the current time 1302 is 2 pm on July 16^{th}, both of the controlling processes for these domains 630, 640 are Past Due. Turning to table 1000, row 1012 indicates that Domain-2 640 should be given a higher priority because its end time is less near the current time 1302. Similarly, both Domain-3 650 and Domain-4 660 have a controlling process with a category of Current 920. Table row 1022 indicates that Domain-4 660 has the higher priority, since its ending date (July 21) is closer to the current time 1302 than the ending time (July 28) of Domain-3 650. Domains A 612 and B 614 do not need to be analyzed under table 1000 since they have different chronological categories (Current 920 and Upcoming 930, respectively).

Following prioritization of the process or occurrence within the domain, the chart system 200 then automatically and continuously repositions domains within the chart or tier within the chart based on the highest-priority process or occurrence within the domains. As mentioned above, the preferred embodiment shows each domain 260 in an interface with processes 270 presented within the icon or graphical object that represents the domain, as was shown for domain 630 in FIG. 11. As a result, the organization of tiers 250 and domains 260 shown in FIG. 13 would ideally be presented generally as shown in interface 1400 of FIG. 14. Of course, in the interest of space, the individual processes are not shown in FIG. 14 but would be shown in the actual interface in the manner similar to that shown in FIG. 11. In some embodiments, all processes 270 will be shown within a domain icon shown in Interface 1400. When large numbers of processes 270 are present, for ready perception, the domain icons may be resized to display only the highest priority process in each domain. This scaling of domains is step 1216 of method 1200. Regardless, in this instance, the totality of processes 270 will remain fully concatenated.

Of course, the prioritization and presentation of tiers 250, domains 260, and processes 270 shown in interface 1400 will not be static over time. Based on the changing current time 1402, change in start or end times, completion of processes 270, changes in process category or precedential chronology, the priority order of processes 270 within domains 260 and tiers 250 within interface 1400 will need to be altered. In the preferred embodiment, these elements are automatically and continuously analyzed and reconfigured, and the relative position/scale/color/designator of domains 260 within the interface 1400 are also automatically changed to continuously denote the current priority of all processes 270. This reanalysis can occur periodically (such as every minute or every five minutes) and can also be triggered by any and all changes to the data 240 made by the users.

At step 1218, the organized interface 1400 is presented to the user, and the method 1200 ends. The presented interface 1400 allows a user or user group to readily perceive the practical order, for execution or instance, of all the user's, the user group's, or the organization's domains 260 and processes 270 over any period. Further, the present chart system 200 allows a user to display the relationships of domains 260 and processes 270 to show their work. This dynamic graphing of tier-ranked and prioritized domains 260 within a user interface 1400, and the listing of prioritized and precedentially ordered processes 270 within the domains 260 greatly improves a users' ability to perceive the practical order for execution or incident of all organization processes 270. This more comprehensive, yet simplified interface substantially improves an individual's or team's ability to plan, manage and execute any number of processes associated with any number of organization functions over any period.

### Task Oriented Interface 1500

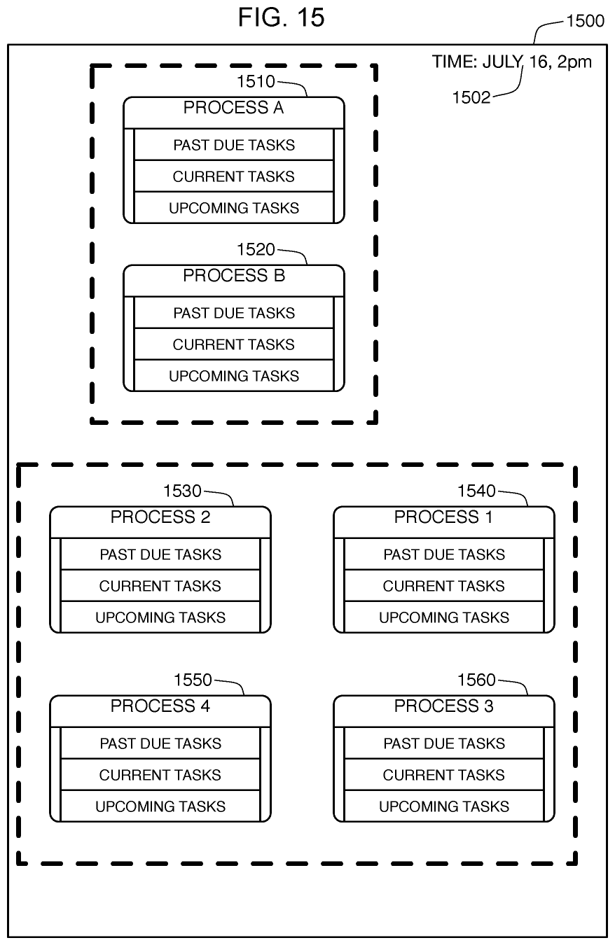

As explained above in connection with hierarchy 300, each process 270 can be associated with a plurality of individual tasks 280. It is possible to implement an embodiment of the present invention that focuses on tasks 280 and the use of task prioritization or organize a display of processes 270 to develop a task-oriented interface 1500 as shown in FIG. 15. Just as interface 1400 categorized processes 270 into chronological categories 902, applied an internal category prioritization (table 1000), and then assigned a controlling process for each domain 260 in order to organize and present domain 260 and process 270 information, Interface 1500 does the same thing for process 270 and task 280 information.

Instead of each process 270 being manually assigned a beginning and ending time, each task 280 is assigned a beginning and ending time. Each task can then be assigned a chronological category 902, in the same manner as these categories were assigned to processes 270. Internal category prioritization in the manner set forth in table 1000 can be used to prioritize tasks 280. Each process 270 can then be assigned a controlling task, which is the task 280 having the highest overall rank or priority that is assigned to that process 270. The organized processes 270 can then be presented as shown in interface 1500, with the current time 1502 being used to control categorization and internal category prioritization. Process A 1510 and Process B 1520 can be separately organized in the same manner as Domain A 612 and Domain B 614. For instance, these processes 1510, 1520 can be grouped together because they are both associated with the same domain 260 in the database 240. Similarly, processes 1530-1560 are grouped together. Each process 1510-1560 in display 1500 displays its associated tasks 280 grouped according to the chronological categories assigned to the tasks 280.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computer implemented method for presenting an improved user interface for analyzing processes and domains comprising:
a) using a computer system to access a database having:
i) domain records each having a title attribute, and
ii) process records, each process record being associated with one domain record and further having:
(1) a title attribute,
(2) a start time attribute, and
(3) an end time attribute;
b) using the computer system to assign chronological categories to the process records by comparing the start time attributes and end time attributes against a current time;
c) using the computer system to group the process records associated with each domain records by chronological categories and sorting the groupings by a category rank assigned to each of the chronological categories;
d) using the computer system to rank process records within each chronological category using an internal category prioritization, whereby the combination of category rank and internal category prioritization comprise an overall rank for the process;
e) using the computer system to identify a controlling process for each domain, the controlling process being the process associated with the domain having the highest overall rank; and
f) using the computer to present a user interface showing the domain records and the process records, wherein:
i) data from a plurality of displayed domain records are presented through domain graphical objects on the user interface, with each domain graphical object being associated with a single one of the displayed domain records, wherein the domain graphical objects display the value of the title attribute of their associated displayed domain record,
ii) each domain graphical object displays data from process records associated with the displayed domain record associated with the domain graphical object, and
iii) the domain graphical objects are organized on the user interface based upon the overall rank of the controlling processes for each displayed domain record.

2. The method of claim 1, wherein the domain graphical objects in the user interface are ranked relative to one another by the overall rank of the controlling process, with higher ranked domain graphical objects being positioned in a higher-ranked position in the user interface.

3. The method of claim 2, wherein the higher-ranked position is located toward the top of the user interface.

4. The method of claim 2, wherein the higher-ranked position is located toward the left of the user interface.

5. The method of claim 1, wherein the database further has tier records, further where a plurality of domain records are associated with single tier records, and further wherein the domain graphical objects are grouped together in the presented user interface according to their associated tier records.

6. The method of claim 5, wherein domain graphical objects are first grouped together as cohorts according to associated tier records, and then organized within each cohort based upon the overall rank of the controlling processes.

7. The method of claim 6, wherein a subset of domain records are not associated with any tier records, and the subset of domain records comprise their own cohort that are organized on the user interface based upon the overall rank of the controlling processes.

8. The method of claim 1, wherein steps b) through f) are repeated over time, thereby automatically updated assigned categorical assignments to processes based on changes to the current time and resulting in a changing user interface over time.

9. The method of claim 8, wherein each process record contains a completion attribute, and further wherein process records are ignored in steps b) through f) where the completion attribute indicates that the process has been completed.

10. The method of claim 1, wherein the chronological categories comprise:
i) a past due category where the end time attribute for the process is before the current time,
ii) a current category where the start time attribute for the process is equal to or before the current time and the end time attribute is equal to or after the current time, and
iii) an upcoming category where the start time attribute for the process is after the current time.

11. The method of claim 10, wherein the past due category has a higher rank than the current category, and the current category has a higher rank than the upcoming category.

12. The method of claim 10, wherein the data from the process records displayed within the domain graphical objects are grouped together in the user interface based on the chronological category assigned to each process.

13. The method of claim 10, wherein:
i) the internal category prioritization for the past due category is primarily based on the farness of the end time attribute to the current time, and is secondarily based on the farness of the start time attribute to the current time,
ii) the internal category prioritization for the current category is primarily based on the closeness of the end time attribute to the current time, and is secondarily based on the farness of the start time attribute to the current time, and
iii) the internal category prioritization for the past due category is primarily based on the closeness of the start time attribute to the current time, and is secondarily based on the closeness of the end time attribute to the current time.

14. The method of claim 1, wherein the chronological categories comprise:
i) a current category where the start time attribute for the process is equal to the current time,
ii) a past due category where the end time attribute for the process is before the current time,
iii) an ongoing category where the start time attribute for the process is before the current time and the end time attribute is on or after the current time, and
iv) an upcoming category where the start time attribute for the process is after the current time.

15. The method of claim 1, further comprising the step of using the computer system to receive a time frame from the user, wherein data from process records displayed on the user interface is limited to process records having start time attributes before or within the time frame.

16. The method of claim 1, wherein the database further has:
iii) task records having a start time attribute and an end time attribute, further wherein each task record is associated with one process record.

17. The method of claim 16, wherein the start time attribute of the process records is determined by examining the start time attributes of associated task records, further wherein the end time attribute of the process records is determined by examining the end time attributes of associated task records.

18. A computer implemented method for presenting an improved user interface for analyzing processes and domains comprising:
a) using a computer system to access a database having:
i) process records each having a title attribute, and
ii) task records, each task record being associated with one process record and further having:
(1) a title attribute,
(2) a start time attribute, and
(3) an end time attribute;
b) using the computer system to assign chronological categories to the task records by comparing the start time attributes and end time attributes against a current time;
c) using the computer system to group the task records associated with each process records by chronological categories and sorting the groupings by a category rank assigned to each of the chronological categories;
d) using the computer system to rank task records within each chronological category using an internal category prioritization, whereby the combination of category rank and internal category prioritization comprise an overall rank for the task;
e) using the computer system to identify a controlling task for each process, the controlling task being the task associate with the process with the highest overall rank; and
f) using the computer to present a user interface showing the process records and the task records, wherein:
i) data from a plurality of displayed process records are presented through process graphical objects on the user interface, with each process graphical object being associated with a single one of the displayed process records, wherein the process graphical objects display the value of the title attribute of their associated displayed process record,
ii) each process graphical object displays data from task records associated with the displayed process record associated with the process graphical object, and
iii) the process graphical objects are organized on the user interface based upon the overall rank of the controlling tasks for each displayed process record.

19. A system for generating a process-oriented user interface comprising:
a) a database having:
i) domain records each having a title attribute, and
ii) process records, each process record being associated with one domain record and further having:
(1) a title attribute,
(2) a start time attribute, and
(3) an end time attribute;
b) a processor;
c) memory; and
d) programming within the memory programming the processor to:
i) assign chronological categories to the process records by comparing the start time attributes and end time attributes against a current time,
ii) group the process records associated with each domain records by chronological categories and sorting the groupings by a category rank assigned to each of the chronological categories,
iii) rank process records within each chronological category using an internal category prioritization, whereby the combination of category rank and internal category prioritization comprise an overall rank for the process,
iv) identify a controlling process for each domain, the controlling process being the process associated with the domain having the highest overall rank, and
v) present a user interface showing the domain records and the process records, wherein:
(1) data from a plurality of displayed domain records are presented through domain graphical objects on the user interface, with each domain graphical object being associated with a single one of the displayed domain records, wherein the domain graphical objects display the value of the title attribute of their associated displayed domain record,
(2) each domain graphical object displays data from process records associated with the displayed domain record associated with the domain graphical object, and
(3) the domain graphical objects are organized on the user interface based upon the overall rank of the controlling processes for each displayed domain record.

20. The system of claim 19. wherein the domain graphical objects in the user interface are ranked relative to one another by the overall rank of the controlling process, with higher ranked domain graphical objects being positioned in a higher-ranked position in the user interface.
